(19) United States
(12) Patent Application Publication
(10) Pub. No.: US 2022/0036875 A1
(43) Pub. Date: Feb. 3, 2022

(54) METHOD AND DEVICE FOR OUTPUTTING AN AUDIBLE VOICE MESSAGE IN AN ELEVATOR SYSTEM

(71) Applicant: Inventio AG, Hergiswil (CH)

(72) Inventor: Stefano Carriero, Cham (CH)

(21) Appl. No.: 17/309,436

(22) PCT Filed: Nov. 6, 2019
(86) PCT No.: PCT/EP2019/080398

§ 371 Date: May 27, 2021

(30) Foreign Application Priority Data
Nov. 27, 2018 (EP) 18208438.4

(51) Int. Cl. G10L 13/04; G06F 40/58; B66B 3/00; B66B 1/34

(52) U.S. Cl. CPC G10L 13/04; G06F 40/58; H04L 67/06; B66B 1/3461; B66B 3/00

(57) ABSTRACT

A method and a device for outputting an audible voice message in an elevator system includes at least the following steps: transmitting the content of the voice message as a text file to be output via the Internet to a web-based text-to-speech service provider; receiving an audio file from the service provider via the Internet, the audio file having been created based upon the transmitted text file to be output; and outputting the audio file in the elevator system as the audible voice message. If necessary, the text file to be output can be obtained by translating a source language text file into a target language beforehand with the aid of a translation service provider. The targeted use of online service providers allows the outlay needed to realize voice announcements in an elevator system at different use locations with different languages to be greatly reduced.

### FIELD

The present invention relates to a method and device for outputting an audible voice message in an elevator system. The invention also relates to a computer program product which is set up to carry out or control the described method, and to a computer-readable medium on which such a computer program product is stored.

### BACKGROUND

Regulations or rules that regulate the operation of elevators can stipulate that information about a status of an elevator must be given in a manner that is audibly perceptible for a passenger. The status of the elevator can include, for example, a current or desired position of an elevator car. For example, it may be required that a floor on which the elevator car is currently located, which the elevator car is approaching or which has been selected as the destination floor, for example by inputting on a control panel, is aurally perceptible, i.e. is given in a manner that is audibly perceptible for a passenger. As an alternative or in addition, information about any malfunctions that may occur in the elevator can be output in an aurally perceptible manner as the status of the elevator.

It can be provided, for example, that the current status of the elevator, that is to say, for example, a current position of the elevator car, is communicated with the aid of speech. The audible output of information about the elevator status by means of voice is referred to herein as an audible voice message or, in some cases, as a voice announcement. Such a voice message transmits information to a passenger aurally and in a language that the passenger can understand. It is particularly helpful for disabled people, for example blind people, but can also make it easier for other passengers to use the elevator.

However, this may require that, depending on where an elevator is to be used, voice messages must be output in the elevator system in a local language. Since elevators are usually developed and manufactured for a large number of different markets in different countries, this can mean that elevator manufacturers have to make considerable effort to provide voice messages in a variety of languages in an elevator and then to customize the elevator in such a way that the voice messages are output in the local language. It is usually necessary to store the voice messages to be output in the form of audio files, for which a considerable data storage space can be provided in the elevator system.

### SUMMARY

Thus, among other things, there may be a need for a method and a device with the aid of which it is possible to reduce the outlay and/or the data storage space to be kept available in order to be able to output voice messages audibly in an elevator system. Furthermore, there may be a need for a computer program product which is set up to implement or control such a method, as well as for a computer-readable medium on which such a computer program product is stored.

Such a need can be met with the subject matter according to the advantageous embodiments defined in the following description.

According to a first aspect of the invention, a method for outputting an audible voice message in an elevator system is proposed. The method comprises at least the following steps, preferably in the specified order:
transmitting a content of the voice message as a text file to be output via the Internet to a web-based text-to-speech service provider;
receiving an audio file from the text-to-speech service provider via the Internet, the audio file having been created by the text-to-speech service provider on the basis of the transmitted text file to be output; and
outputting the audio file in the elevator system as the audible voice message.

According to a second aspect of the invention, a device for outputting an audible voice message in an elevator system is described, the device being configured to carry out or control a method according to an embodiment of the first aspect of the invention.

According to a third aspect of the invention, a computer program product is described which has computer-readable instructions which, when executed on a computer-controlled device, instruct the latter to carry out or control a method according to an embodiment of the first aspect of the invention.

According to a fourth aspect of the invention, a computer-readable medium having a computer program product stored thereon according to an embodiment of the third aspect of the invention is proposed.

Possible features and advantages of embodiments of the invention can be considered, among others, and without limiting the invention, to be based on the ideas and findings described below.

As already noted in the introduction, the effort that has to be made with regard to the hardware and/or software to be kept available as well as with regard to the necessary preparatory work in order to be able to output voice messages in an elevator system can be considerable. In particular, it is usually necessary to record the content of the voice message to be output in the form of an audio file and then to store the audio file in a sufficiently large data memory within the elevator system.

A conventional approach to achieve this is, for example, that the voice message is read out by a person and this is recorded with the aid of a microphone. The effort that must be made to record the voice messages can be considerable. The analog audio signals generated in this way can be digitized and then saved as an audio file, such audio files typically requiring a large amount of data storage space.

In order to reduce this effort, it is proposed that the content of the voice message to be output is initially only saved as a text file in the elevator system. Such a text file is easy to create and requires little data storage space.

The text file can then be transmitted to a web-based text-to-speech service provider. Such text-to-speech service providers provide a service in which a text file can be transmitted to the service provider via the Internet and the service provider then converts the content of the text file into an audibly perceptible voice message and for this purpose transmits a corresponding audio file back to the sender.

A computational effort that is required to convert the text file into the audio file can be considerable in this case, but is performed by the external text-to-speech service provider. Accordingly, the sender, that is to say in the present case the elevator system, does not need a corresponding computing capacity. The manufacturer of the elevator system also does not need such a computing capacity.

Instead, it can be sufficient that initially only the various text files to be output by it as voice messages are stored in the elevator system, that a connection can be established via the Internet to the text-to-speech service provider and that then the audio files sent back from the external text-to-speech service provider can be output in the elevator system as audible voice messages. The use of the external text-to-speech service provider can thus reduce the requirements for hardware to be kept available in the elevator system.

The content of the information that is ultimately to be output as an audible voice message can be stored in the elevator system as a text file to be output. For this purpose, for example, an elevator manufacturer can create desired text files and store them in the elevator system. The text file to be output gives the information content already in a language required for output. The text file can include text data, for example in the form of ASCII codes. Typically, the text file is only a few bytes or a few kilobytes long, that is to say as a rule less than 10 kB or at least less than 100 kB. Such short text files can be stored in a relatively small data memory and transmitted via the Internet with relatively low bandwidths. In particular, text files can be very well or very heavily compressed, for example using known data compression methods such as zip, gzip, bzip2, etc.

The audio file generated by the text-to-speech service provider reproduces the content of the text file to be output as an audibly perceptible voice message. For this purpose, the audio file can be created in various digital file formats, for example as a .wav file or .mp3 file. The audio file is usually considerably larger than the original text file. Corresponding audio files typically require a storage space of several hundred kilobytes up to many megabytes. The audio files can be generated or synchronized with a sample rate, resolution and bit rate that ensures sufficient intelligibility of the audibly output voice message. Usually, a sample rate of 8 kHz or more, preferably more than 10 kHz, is used. Typically, 8 bits or 16 bits are used as the resolution. If necessary, the audio files can be transmitted in a compressed manner via the Internet and/or stored in the elevator system before they are then decompressed before being output.

The content of the voice message to be output may possibly not be available from the beginning as a text file to be output in the elevator system. Instead, for example, it is possible to store in the elevator system a type of basic text file which contains the content of the voice message, but not in a manner or language that can be understood by people. For example, the content of the voice message can be stored in a compressed manner and/or in a language other than that of the assumed passengers of the elevator system.

In particular, it can be provided that a text file which is formulated in a source language and which is therefore referred to herein as a source language text file is first translated into another language before it is then sent to the text-to-speech service provider as a text file to be output.

For this purpose, according to one embodiment, the method described here can further comprise supplementary method steps before the step of transmitting the text file to be output to the text-to-speech service provider, in particular transmitting the content of the voice message as a source language text file via the Internet to a web-based translation service provider and specifying information relating to a target language to the translation service provider, and receiving the text file to be output from the translation service provider via the Internet, the text file to be output having been created by the translation service provider by machine translation of the transmitted source language text file into the specified target language.

In other words, it can be provided that the content of a voice message to be output is initially only written in one source language and is stored in the elevator system as a source language text file. For example, the source language text file can be generated in a language that is familiar to the manufacturer of the elevator, for example English or German.

The source language text file can then be transmitted via the Internet to a web-based translation service provider. Such translation service providers provide a service in which a message can be transmitted in a source language, for example in the form of a text file, and the translation service provider then translates this message into a target language.

The translation service provider may optionally be able to translate into a variety of possible languages. Therefore, together with the source language text file, information relating to the desired target language should also be transmitted to the translation service provider. The target language is usually known for a given elevator system, since it is, for example, part of the order data and is therefore incorporated into the elevator configuration.

The translation service provider can usually access large databases and/or translation know-how for its translation work, which enables it to automatically translate the source language text file into a correct and easily understandable text file in the target language. If necessary, the translation service provider can also use artificial intelligence for this purpose.

The translation of text files can require considerable computing effort and/or access to large databases. Since the translation of the source language text file into the text file that is ultimately to be output in the target language is outsourced to the translation service provider, neither the manufacturer of the elevator system nor the elevator system itself needs corresponding computing capacity and/or databases to be kept available.

According to one embodiment, a large number of contents of different voice messages can be stored in a component of the elevator system and transmitted to the text-to-speech service provider before the elevator system is put into operation. The audio files received in each case can then be temporarily stored in the same component or in a different component of the elevator system before one of the up-to date audio files is output.

In other words, it can be provided that, for example, a manufacturer of an elevator system stores the contents of various voice messages in a component of the elevator system that has a data memory as part of a manufacturing process or a configuration process. Such a component can, for example, be a control of the elevator system.

The contents of the voice messages can already be generated and stored as text files to be output or as source language text files, which then first have to be translated into text files to be output.

In the second case, the voice messages can be specified as source language text files in a single source language. Before the elevator system is put into operation, it sends the source language text files to the translation service provider via the Internet and also specifies the target languages into which the source language text files are to be translated. The translations generated by the translation service provider can then be stored in a database within the elevator system, whereby, for example, a separate data record of translated text files to be output can be provided for each desired target language.

Before the elevator system is put into operation, the text files to be output are then transmitted to the text-to-speech service provider. The audio files generated by the text-to-speech service provider can then be stored in the elevator system. For example, a component of the elevator system, such as its control, can have an electronic data memory in which the audio files can be stored, for example in the form of a database.

Thus, before the elevator system is put into operation the audio files can already be generated by the external service provider and stored in the elevator system so that, when required, that is when a voice message is currently to be output, they can be read out of the memory and can be output via an output device such as, for example, a loudspeaker. This enables voice messages to be output quickly and with little delay while the elevator system is in operation.

According to one embodiment, the audio files can be updated at regular time intervals by retransmitting the contents of the voice messages to the text-to-speech service provider and receiving the audio files again.

In other words, it can be provided that the audio files are not only generated once, in that the underlying text files to be output are transmitted to the text-to-speech service provider and the audio files then obtained are stored. Instead, it can be provided that the audio files are updated at regular time intervals, in that the text files to be output are again transmitted to the text-to-speech service provider and the audio files then received replace previously stored versions of these audio files.

In this way, for example, technological developments at the text-to-speech service provider, which can lead to an improvement in the quality of the audio files generated over time, are actually also used to replace audio files generated at an earlier point in time with lower quality audio files by higher quality audio files that are now available.

According to an alternative embodiment, a large number of different voice messages can be stored in a component of the elevator system, with the content of a voice message currently to be output being selected from the stored voice messages as a text file to be output to the text-to-speech service provider and the audio file then received is output directly.

In other words, as an alternative to the embodiment described above, in which the audio files were already generated and stored before they were actually needed, provision can be made for a specific need to be awaited for which a voice message is to be output and only then the associated text file is transmitted to the text-to-speech service provider and the audio file, which is then received promptly, is output directly, i.e. without being temporarily stored for a substantial period of time.

Thus, with such an “on-the-fly” approach, the audio file for a voice message to be output is always generated in up-to-date form. It is not necessary to update saved messages. If there is a sufficiently fast communication link to the text-to-speech service provider and, if necessary, to the translation service provider, an audio file can always be generated in this way that meets the currently highest possible quality standards for text-to-speech conversion and is possibly derived from a machine translation.

The device according to an embodiment of the second aspect of the invention can be configured with the aid of suitable hardware and/or software to carry out a method according to an embodiment of the invention described herein. In general, the device can have at least one suitable data memory for this, in which text files and/or audio files can be stored. In addition, the device can have suitable interfaces via which data can be exchanged with the Internet and ultimately with external service providers. Furthermore, the device can have a suitable output device or can communicate with such an output device in order to be able to output the generated and, if necessary, temporarily stored audio files as audible voice messages.

According to a specific embodiment, the device can have a first and a second data interface and an output device for this purpose. The first data interface is set up to transmit the content of the voice message as a text file to be output via the Internet to a web-based text-to-speech service provider. The second data interface is set up to receive an audio file from the text-to-speech service provider via the Internet, the audio file being created by the text-to-speech service provider based on the transmitted text file to be output. The output device is set up to output the audio file in the elevator system as the audible voice message.

The two interfaces can be designed with separate hardware. Alternatively, however, the two interfaces can also be implemented in common hardware. Due to their hardware and/or software, each of the two interfaces can be configured for the particular one of the specified functionalities. The first data interface can be set up, for example, to read out one of the text files stored in a data memory and to transmit it to the text-to-speech service provider via the Internet. If necessary, the text files can be embedded in a suitable data protocol and/or compressed. The second data interface can be set up, for example, to read in the audio files generated by the text-to-speech service provider in order then to either temporarily store them or to transmit them directly to the output device.

The output device can in particular have a loudspeaker, with the aid of which the voice message can be output in an audibly perceptible manner. For this purpose, an audio file that is initially mostly digital can be converted into an analog signal before or during output.

According to a further specific embodiment, the device can furthermore comprise a third data interface and a fourth data interface. The third data interface can be configured to transmit the content of the voice message as a source language text file via the Internet to a web-based translation service provider and to provide information relating to a target language to the translation service provider. The fourth data interface can be configured to receive the text file to be output from the translation service provider via the Internet, the text file to be output being created by the translation service provider by machine translation of the transmitted source language text file into the specified target language.

In other words, the device described herein can also have two data interfaces via which it can communicate with the translation service provider. The two data interfaces can in turn be designed as separate units or with the aid of a common hardware and, based on their hardware and/or software, can be set up for the stated functionalities.

According to a specific embodiment, the device described herein can furthermore comprise a gateway server, an emergency call device and a digital-to-analog signal converter. The gateway server can be configured for digital transmission of files via the Internet. The emergency call device can be configured to set up voice communication between a person in the elevator system and a control center in an emergency situation, and for this purpose it can be configured to transmit analog audio signals to the output device. The digital-to-analog signal converter can be configured to convert a digital audio file that was received via the gateway server into an analog audio signal that is to be forwarded to the output device.

In other words, the device described can make use of the fact that emergency call devices are already provided in many elevator systems, with the aid of which, for example, a passenger trapped in an elevator car should be able to communicate with a control center. The emergency call device can have a loudspeaker and, if necessary, a microphone, which can be used to convert electrical signals into audible signals or vice versa. In each case the signals are analog. To output audible voice messages, the device can also have the digital-to-analog signal converter to convert digital audio files that were previously received via the gateway server and, if necessary, temporarily stored, into analog audio signals so that they can then be output via the loudspeaker of the output device as an audible voice message.

Thus, according to this embodiment the gateway server and the digital-to-analog signal converter are designed in such a way that text files to be output are transmitted to the external text-to-speech service provider and audio files that are then generated can be received and the audio files are then converted directly by the digital-to-analog signal converter into analog audio signals which can be output by the emergency call device which in any case is often provided in an elevator system.

Thus, the method presented here can be implemented with little expenditure on hardware. In particular, use can be made of the fact that a gateway server and/or a digital-to-analog signal converter are often already provided for other purposes in modern elevator systems. These components can be used with relatively little outlay, for example by executing suitably programmed software in the existing hardware, in order to establish communication with the text-to-speech service provider and, if necessary, with the translation service provider and to output received audio files.

Alternatively, according to one embodiment, the device described herein can furthermore have a gateway server, an elevator controller and an output device. The gateway server can be configured for digital transmission of files via the Internet. The elevator controller can be configured to control functions of components of the elevator system. Furthermore, it can be configured for the digital transmission of files to the output device. The output device can be part of a control panel and the control panel can have a digital-to-analog signal converter which can be configured to convert a digital audio file, which was received via the gateway server and forwarded to the control panel via the elevator controller, into an analog audio signal which is to be forwarded to the output device.

In other words, according to this embodiment, components which in any case are often provided in elevator systems can be used to carry out embodiments of the method described herein. In particular, use can be made of the fact that already in many modern elevators the elevator controller not only serves to control functions of components of the elevator system, but is also already set up for communication via a network, in particular via the Internet.

For example, the elevator controller can communicate with a remote monitoring center via a gateway server in order to be able to report malfunctions, for example. In this case, for example, a loudspeaker which is provided in one of the control panels of the elevator system can serve as the output device. For example, a car operation panel (COP) can be provided in the elevator car in which a loudspeaker is provided in order, for example, to be able to transmit messages to trapped passengers in emergency situations. The control panel can have a digital-to-analog signal converter that can be used to convert the original digital audio signals into analog audio signals in order to be able to output them as audibly perceptible voice messages via the output device.

Embodiments of the method described herein can be implemented in particular with the aid of a computer program product according to the third aspect of the invention. The computer program product in this case comprises instructions that can be interpreted by a computer or a computer-controlled device and can instruct them to carry out or control the described method. The computer program product can be used, for example, to program a programmable elevator controller. For example, the computer program product can include instructions with the aid of which the programmable elevator controller can be made to communicate in the manner described herein with a web-based text-to-speech service provider and, if necessary, additionally with a web-based translation service provider, and to output audio files thus obtained as audible voice messages. The computer program product can be programmed in any computer language.

In particular, the computer program product can be stored on any computer-readable medium. Such a computer-readable medium can be, for example, a CD, a DVD, a flash memory, a ROM, a PROM, an EPROM or the like. The computer-readable medium can also be another computer or server from which the computer program product can be downloaded. Such a further computer or server can be part of the Internet or a data cloud.

It should be noted that some of the possible features and advantages of the invention are described herein with reference to different embodiments which relate in part to the presented method and in part to the device which can be used for carrying it out. A person skilled in the art recognizes that the features may be combined, adapted, transferred or exchanged as appropriate in order to arrive at other embodiments of the invention.

Embodiments of the invention will be described below with reference to the accompanying drawings, with neither the drawings nor the description being intended to be interpreted as limiting the invention.

### DESCRIPTION OF THE DRAWINGS

FIG. 1 schematically illustrates components of a device for outputting audible voice messages in an elevator system according to an embodiment of the present invention.

The figure is merely schematic and is not to scale.

### DETAILED DESCRIPTION

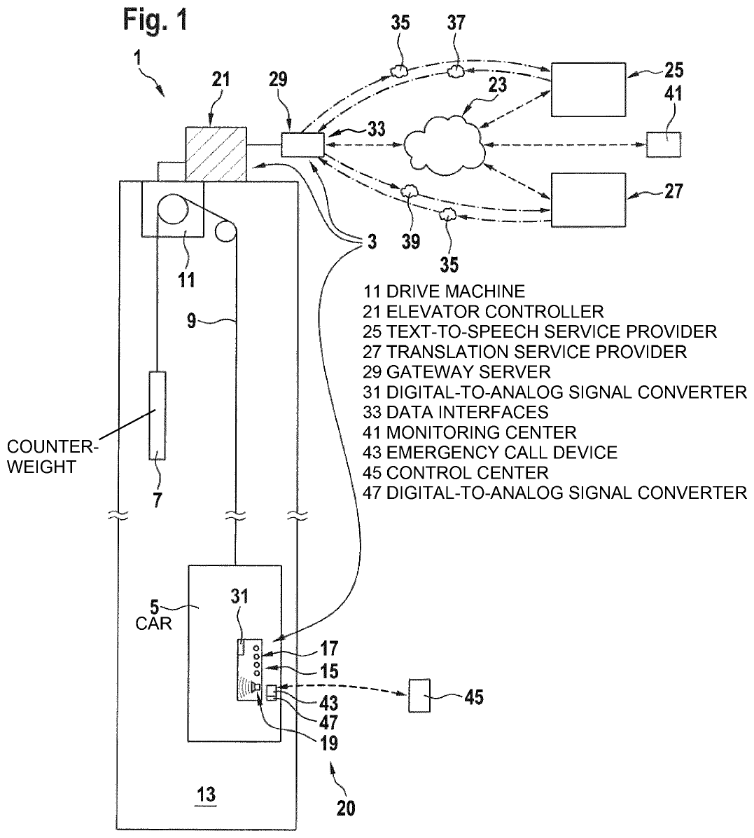

FIG. 1 shows an elevator system 1 with a device 3 for outputting audible voice messages in the elevator system 1 according to an embodiment of the present invention.

The elevator system 1 has an elevator car 5 and a counterweight 7, which are connected to one another via a common suspension element 9 and can be moved by a drive machine 11 by moving the suspension element 9 within an elevator shaft 13. In the elevator car 5, a car control panel 15 is provided which, among other things, has control buttons 17 and a loudspeaker 19. By actuating one of the control buttons 17, a passenger can enter a desired destination floor and this information can be transmitted to an elevator controller 21, which can then control the drive machine 11 in a suitable manner in order to move the elevator car 5 to the destination floor.

In addition to visual information which is usually to be provided about the current state of the elevator system 1 and in particular about a current or desired position of the elevator car 5, provision can also be made to communicate the current status of the elevator car 1 to a passenger in an audibly perceptible manner.

Traditionally, voice announcements in different languages had to be recorded with the help of specialized translators in each country in which the elevator system was to be used. The translated announcements then had to be checked and integrated into the product structure of the elevator system. The audio files had to be numbered according to a specific overview structure. During an order process, the correct set of audio files had to be ordered and then stored in a storage medium. The storage medium was then inserted into the hardware of the elevator system during the installation and customer-specific adaptation of the elevator system. Based on the numbered audio files, an audio player in the elevator system could then play the corresponding audio files. The entire process described was very complex, both in terms of the work that was necessary to prepare and translate the voice messages and in terms of keeping the hardware available for this purpose.

In addition, it could happen again and again that users of the elevator system requested that some words of voice messages should be changed or that entire announcements which were, for example, incorrectly pronounced, should be modified. The process described above for this is labor-intensive and takes a lot of time.

In order to remedy the said disadvantages, therefore, a new approach is described in which audible voice messages can be generated and output in an elevator system in a largely automated manner.

For example, in this case the elevator controller 21 may be able to recognize situations in which certain voice messages should be output. Furthermore, when planning or manufacturing the elevator system 1, it can already be determined which contents of voice messages should be output in which situations.

The voice messages can initially be transmitted as a text file 35 to be output via the Internet 23 to a web-based text-to-speech service provider 25. For this purpose, the elevator system 1 can use a gateway server 29, for example, which can communicate with the elevator controller 21, for example. The gateway server 29 can also be used to implement other functions. For example, the elevator system can communicate with a monitoring center 41 via the gateway server 29. With the aid of the gateway server 29, the elevator system 1 can transmit a text file 35 to be output to the text-to-speech service provider via the Internet 23. For this purpose, the gateway server 29 has, for example, one or more data interfaces 33 for connection with the Internet 23.

A text file can already be held in the elevator system 1 as a text file 35 to be output, i.e., for example, as text in a language that is customary at the location where the elevator system 1 is installed.

Alternatively, the text file can also reproduce the content of the voice message to be output in another way. In particular, the text file can be formulated as a source language text file 39 in another language.

In this case, the text file 35 to be output can be generated in advance in that the source language text file 39 is also transmitted via the Internet 23 to a special web-based translation service provider 27 by which, after translation of the source language text file 39, transmits the text file 35 to be output back to the elevator system 1 in a specified target language via the Internet 23. The gateway server 29 with its interfaces 33 can also be used for this function if necessary.

The text-to-speech service provider 25 can then, based on the received text file 35 to be output, generate an audio file 37 which, when played, reproduces the content of the voice message contained in the text file 35 in an audible, i.e. aurally perceptible manner. This audio file 37 can be transmitted back to the elevator system 1 via the Internet 23 and the gateway server 29.

There, the audio file 37 can be passed, for example via the elevator controller 21, to a digital-to-analog signal converter 31 contained in the car control panel 15 and converted there into an analog signal. Such an analog signal can then be output, for example, via the loudspeaker 19 in the car control panel 15, which thus serves as output device 20.

Alternatively, the audio file 37 can be output with the aid of an emergency call device 43. The emergency call device 43 usually serves to be able to establish communication with a control center 45. A digital-to-analog signal converter 47, in which the digital audio file 37 can be converted into an analog signal so that it can then be output via the loudspeaker 19 as an output device 20, can be provided in the emergency call device 43 or separately therefrom.

In other words, an idea on which the method described here and the device provided for its implementation are based can be seen in the use of a permanent online connection, which can be provided by a gateway server 29 of the elevator system 1 and enables a connection to the Internet and various services offered there in order, if necessary, to download previously translated voice announcements as audio files in a locally customary language using a text-to-speech service provider. Such a text-to-speech service provider 25 is also sometimes referred to as a web speech API. For example, Google, IBM and others offer a text-to-speech API (see e.g. https://cloud. google. com/text-to-speech/docs/basics and https://www.ibm.com/watson/developercloud/text-to-speech/api/v1/curl.html?curl; as of October 2018). Text-to-speech service providers 25 typically offer speech recognition (speech to text) as well as speech synthesis (text to speech).

For embodiments of the method described herein, the contents of voice messages can be stored as text files, for example in the elevator controller 21 or the car control panel 15, in a common language, for example English. They can then be translated into a local language by being transmitted to a translation service provider 27 and having them translated there. Such a translation service provider 27 is offered on the Internet, for example by Google (see e.g. https://translate.google.com/; as at October 2018). The result of the translation can be synthesized into speech using the Web Speech API and then stored as an audio file 37 in a local storage medium in the elevator system 1.

The method presented enables a large number of translated voice announcements with the correct local language and possibly even with the use of a correct accent (for example British English or American English).

Furthermore, an update mechanism with regular updates can be implemented, which makes it possible to replace the voice announcements, for example in the event that the pronunciation of some words has improved over time.

The presented method for outputting audible voice messages can considerably simplify the effort involved in implementing voice announcements in an elevator system, enabling both the amount of work to be reduced and the amount of time to be shortened.

In other words, through the targeted use of online service providers, the effort required to be able to implement voice announcements in an elevator system at different locations with different languages can be significantly reduced.

Finally, it should be noted that terms such as “have,” “comprising,” etc. do not exclude any other elements or steps, and terms such as “an” or “a” do not exclude a multiplicity. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A method for outputting an audible voice message in an elevator system, the method comprising the steps:
storing a plurality of different voice message text files in a component of the elevator system;
selecting one of the text files as a voice message to be output;
transmitting a content of the selected text file via an Internet connection to a web-based text-to-speech service provider;
receiving an audio file from the text-to-speech service provider via the Internet connection, the audio file having been created by the text-to-speech service provider based upon the transmitted selected text file content; and
outputting the audio file, when received from the text-to-speech service provider, in the elevator system as an audible voice message.

13. The method according to claim 12 including, prior to performing the step of transmitting to the text-to-speech service provider, transmitting the content of the selected text file as a source language text file via the Internet connection to a web-based translation service provider with information related to a target language, receiving a translated text file from the translation service provider via the Internet connection, the translated text file having been created by the translation service provider by a machine translation of the transmitted source language text file into the target language, and using a content of the translated text file as the content of the selected text file transmitted to the text-to-speech service provider.

14. The method according to claim 12 wherein the plurality of different voice message text files is stored in the elevator system component and contents of the stored text files are transmitted to the text-to-speech service provider before the elevator system is put into operation, and an audio file associated with each of the text files received from the text-to-speech service provider is temporarily stored in the component or in a different component of the elevator system before being output in the elevator system as an audible voice message.

15. The method according to claim 14 including updating the stored audio files at regular time intervals by retransmitting the contents of the text files to the text-to-speech service provider and receiving updated audio files from the text-to-speech service provider.

16. A computer program product comprising non-transitory computer-readable instructions that, when executed on a computer-controlled device, instruct the device to execute or control the method according to claim 12.

17. A non-transitory computer-readable medium having a computer program product according to claim 16 stored thereon.

18. A device for outputting an audible voice message in an elevator system, the device being adapted to carry out or control the method according to claim 12 using an output device.

19. A device for outputting an audible voice message in an elevator system, the device comprising:
a first data interface transmitting via an Internet connection to a web-based text-to-speech service provider a content of a text file representing a voice message to be output;
a second data interface receiving an audio file from the text-to-speech service provider via the Internet connection, the audio file having been created by the text-to-speech service provider based upon the transmitted text file content; and
an output device outputting the received audio file in the elevator system as an audible voice message.

20. The device according to claim 19 including a third data interface transmitting via the Internet connection the content of the text file as a source language text file to a web-based translation service provider with information relating to a target language, and a fourth data interface receiving a translated text file from the translation service provider via the Internet connection, the translated text file having been created by the translation service provider by machine translation of the transmitted source language text file content into the specified target language, wherein a content of the translated text file is the text file content transmitted by the first data interface.

21. The device according to claim 19 including a gateway server adapted for digital transmission of files via the Internet connection, an emergency call device adapted to set up voice communication between a person in the elevator system and a control center in an emergency situation, the emergency call device being adapted to transmit analog audio signals to the output device, and a digital-to-analog signal converter adapted to convert a digital audio file received via the gateway server into an analog audio signal and forward the analog audio signal to the output device.

22. The device according to claim 19 including a gateway server adapted for digital transmission of files via the Internet connection, an elevator controller adapted to control functions of components of the elevator system and digitally transmit files to the output device, wherein the output device is part of a control panel and the control panel includes a digital-to-analog signal converter adapted to convert a digital audio file that was received via the gateway server and forwarded to the control panel via the elevator controller into an analog audio signal to be forwarded to the output device.
